(19) United States
(12) Patent Application Publication
(10) Pub. No.: US 2026/0111803 A1
(43) Pub. Date: Apr. 23, 2026

(54) SYSTEM AND METHOD FOR FINE-TUNING LARGE LANGUAGE MODELS

(71) Applicant: ACCENTURE GLOBAL SOLUTIONS LIMITED, Dublin 4 (IE)

(72) Inventors: Vivek Kumar KHETAN, San Francisco, CA (US); Devleena DAS, Campbell, CA (US)

(73) Assignee: ACCENTURE GLOBAL SOLUTIONS LIMITED, Dublin 4 (IE)

(21) Appl. No.: 19/362,123

(22) Filed: Oct. 17, 2025

Related U.S. Application Data
(60) Provisional application No. 63/710,404, filed on Oct. 22, 2024.

(51) Int. Cl. G06N 20/20

(52) U.S. Cl. CPC G06N 20/20

(57) ABSTRACT

Systems, methods and computer-readable storage media for finetuning Large Language Models (LLMs) are disclosed. The method includes receiving plurality of first datasets from multiple data sources, extracting base datasets from the plurality of first datasets, and determining section datasets based on the difference between the first and base datasets. The method further includes, determining task complexity and domain complexity for the second datasets, determining appropriate embedded representations using feature vectors, clustering the representations into multiple clusters based on cluster space, latent space, and pre-learned embeddings, sampling he clustered data by determining weights and generating different types of samples based on complexity levels, and fine-tuning of the LLMs using the base datasets and the selected samples.

### CROSS-REFERENCE TO RELATED APPLICATION(S)

This application claims priority to a U.S. Provisional Application No. 63/710,404, filed on Oct. 22, 2024, the entire content of which is hereby incorporated by reference in the entirety for all purposes.

### TECHNICAL FIELD

The present disclosure generally relates to the field of Large Language Models (LLMs) and, more particularly, to a system and a method for fine-tuning Large Language Models.

### BACKGROUND

With recent advancements in Artificial Intelligence (AI), particularly the rise of Large Language Models (LLMs), the reliance on vast datasets for training has become a critical concern. These models require enormous amounts of data to generalize effectively across a wide range of tasks. Despite their impressive capabilities, however, LLMs still face significant limitations in personalization. For instance, a command like “add more detail” can have different meanings depending on individual user intent, yet current LLMs tend to respond in a uniform way across such varied inputs. Furthermore, an Artificial Intelligence (AI) system's understanding of complexity remains closely tied to human-defined benchmarks, posing an ongoing challenge in enabling these systems to recognize and handle complexity from their own perspective. In addition, LLMs continue to rely heavily on large datasets, making it difficult to reduce data requirements without compromising performance. Current approaches are limited in their ability to dynamically interpret and respond to the nuanced differences in user commands, as the models are often trained in a generalized manner that does not account for diverse user inputs.

### SUMMARY

This summary is provided to introduce a selection of concepts in a simple manner that is further described in the detailed description of the disclosure. This summary is not intended to identify key or essential inventive concepts of the subject matter, nor is it intended for determining the scope of the disclosure.

A system and a method for fine-tuning Large Language Models (LLMs) are disclosed. The method includes receiving a plurality of first datasets from a plurality of data sources, wherein the plurality of first datasets correspond to training datasets for training a plurality of LLMs, extracting a plurality of base datasets from the received plurality of first datasets using a stratified sampling model, wherein the plurality of base datasets corresponds to a plurality of base sampled datasets present in the plurality of first datasets, and determining a plurality of second datasets based on the difference between the plurality of first datasets and the plurality of base datasets. The method further includes, determining a task complexity and a domain complexity of the plurality of second datasets by analyzing a type and a context of the plurality of second datasets, wherein the task complexity comprises a level of difficulty based on a number of required operations and interdependence of subtasks, and wherein the domain complexity comprises an intricacy level of subject matter based on breadth of knowledge required and interrelationships among concepts, determining an embedded representation for the plurality of second datasets based on a number of tasks, the determined task complexity, and the determined domain complexity, wherein the embedded representation comprises feature vector representations of the plurality of second datasets, generating a plurality of clustered datasets by clustering the embedded representation of the plurality of second datasets into a plurality of clusters based on a cluster space value, a latent-space representation, and pre-learnt embedding spaces, wherein the plurality of clusters correspond to the number of tasks to be performed. The method further includes, generating a plurality of sampled datasets by sampling the plurality of clustered datasets based on sampling weights and distances to a centroid value of each cluster, wherein the plurality of sampled datasets comprises data samples with a specific complexity value being proximate and distant to the centroid value, and wherein the sampling weights control a proportion of the specific complexity value, selecting appropriate data samples from the generated plurality of sampled datasets based on the sampling weights and the distances to the centroid value of each cluster, performing fine-tuning of the plurality of LLMs using the extracted plurality of base datasets and the selected plurality of sampled datasets, wherein the fine-tuning comprises adjusting model hyper parameters of the plurality of LLMs, generating a plurality of fine-tuned output prompts from each of the fine-tuned plurality of LLMs based on the received plurality of first datasets, and outputting the generated plurality of fine-tuned output prompts on a user interface of a user device, wherein the output prompts being personalized based on user-specific intents derived from the domain complexity and the task complexity.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure is not limited to the combinations of aspects and features specifically described herein but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 depicts an example environment that may be used to execute implementations of the present disclosure;

FIG. 2 depicts an example architecture of a system in accordance with implementations of the present disclosure;

FIG. 3 depicts a block diagram showing a process flow of sampling data for finetuning a plurality of large language models (LLMs) in accordance with implementations of the present disclosure;

FIG. 4 is a flow diagram that presents an exemplary method in accordance with implementations of the present disclosure; and

FIG. 5 illustrates a computer system that may be used to implement the system.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/act involved.

Specific details are provided in the following description to provide a thorough understanding of embodiments. However, it will be understood by one of the ordinary skills in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

To address the one or more limitations described in the background, embodiments of the present disclosure describe a system and a method for fine-tuning Large Language models (LLMs). The proposed system and the method sample the training dataset based on the complexities of tasks and their implementations and reduces data dependency while enhancing the accuracy and adaptability of LLMs across different domains. This approach ensures efficient fine-tuning and improved performance of LLMs.

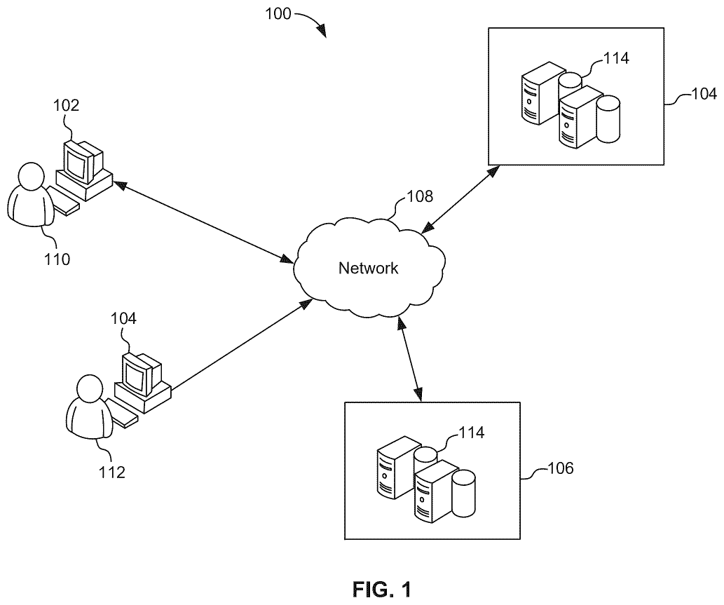

FIG. 1 depicts an example environment 100 that may be used to execute implementations of the present disclosure. In some examples, the example environment 100 enables finetuning of one or more large language models (LLMs).

As depicted in FIG. 1, the example environment 100 includes computing devices 102 and 104, back-end systems 106, and a network 108. In some examples, the computing devices 102 and 104 are used by respective users 110 and 112 to log into and interact with computing platforms executing applications according to implementations of the present disclosure. Examples of the computing devices 102 and 104 may include desktop computing devices, smartphones, laptops, tablet, voice-enabled devices, and/or the like. It is contemplated that implementations of the present disclosure may be realized with any appropriate type of computing device. In some examples, each of the computing devices 102 and 104 may include a web browser application executed thereon, which may be used to display one or more web pages of a computing platform executing applications. In some examples, each of the computing devices 102 and 104 may display one or more Graphical User Interfaces (GUIs) that enable the respective users 110 and 112 to interact with the computing platform.

In some examples, the network 108 includes a Local Area Network (LAN), a Wide Area Network (WAN), the Internet, or a combination thereof, and connects computing devices 102 and 104, and the back-end systems 106. In some examples, the network 108 may include over a wired and/or a wireless communication link.

In some examples, one or more of the back-end systems 106 may be implemented as an on-premises system that is operated by an enterprise or a third-party engaged in cross-platform interactions and data management. In some examples, the back-end systems 106 may be implemented as an off-premises system (for example, cloud or on-demand) that is operated by an enterprise or a third-party on behalf of an enterprise. In some examples, one or more of the back-end systems 106 may be implemented in a cloud environment. For simplicity, the back-end systems 106 depicted in FIG. 1 may be a cloud environment that is intended to represent various forms of servers including a web server, an application server, a proxy server, a network server, a server pool, and/or the like.

According to implementations of the present disclosure, the system 114 may be adapted for finetuning the LLMs. Numerous examples depicting the finetuning of the LLMs are described in detail in conjunctions with figures below.

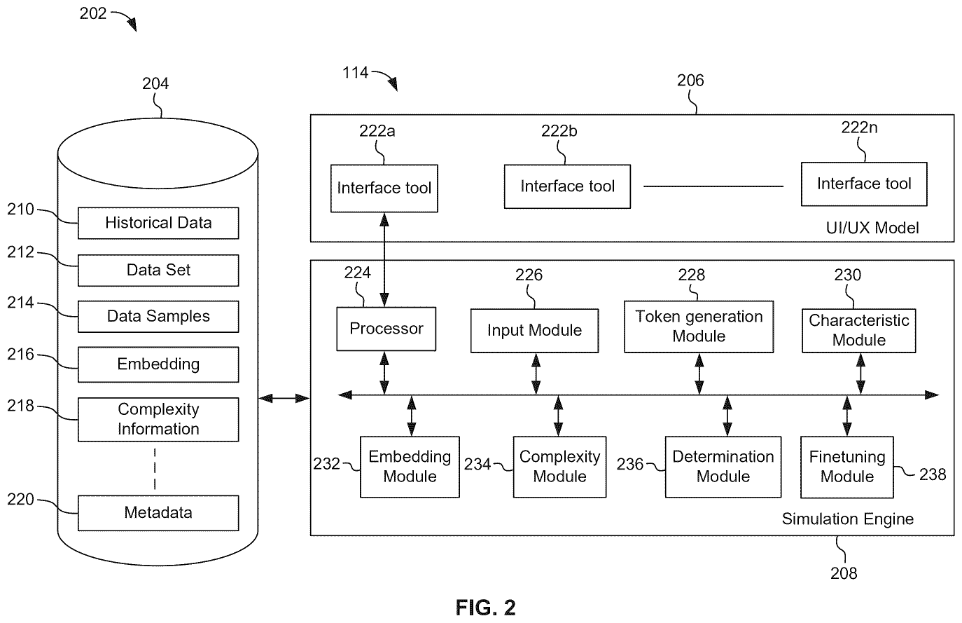

FIG. 2 depicts an example architecture 202 of the system 114 for finetuning the LLMs, in accordance with implementations of the present disclosure. In an example, as depicted in FIG. 2, the system 114 receives a plurality of first datasets from a plurality of data sources. The plurality of data sources may include online data sources, public and private repositories, and proprietary enterprise data sources. For example, datasets could be sourced from academic journals, social media platforms, and e-commerce sites, ensuring a rich variety of data for comprehensive model training. The plurality of first datasets may correspond to training datasets required for training a plurality of Large Language Models (LLMs).

The system 114 includes a knowledge base 204, a User Interface (UI)/User Experience (UX) module 206, and a finetuning engine 208. The knowledge base 204 may be described as a structured repository or database associated with the system 114. The knowledge base 204 may incorporate various knowledge representation schemes, such as ontologies, taxonomies, or semantic networks, to encode and organize information in a machine-understandable format. Furthermore, the knowledge base 204 may leverage advanced technologies, including natural language processing, machine learning, and knowledge engineering techniques, to enhance knowledge acquisition, update, and refinement processes, ensuring its continual relevance and adaptability to evolving needs and circumstances.

In some implementations, the knowledge base 204 includes historical data 210, data set 212, data samples 214, embeddings 216, complexity information 218, metadata 220, and additional information (not shown) pertaining to the system 114. The historical data 210 includes stored knowledge from previous tasks, providing a foundation for the large language model's (LLM) training and fine-tuning. The data sets 212 refer to organized collections of training data used by the system 114 to refine the performance of the LLM, with the data samples 214 representing smaller portions of these data sets categorized by task complexity and relevance to specific objectives.

In some implementations, the knowledge base 204 includes historical data 210, data set 212, data samples 214, embeddings 216, complexity information 218, metadata 220, and additional information (not shown) pertaining to the system 114. The historical data 210 comprises stored knowledge from previous tasks, providing a foundation for the large language model's (LLM) training and fine-tuning. The data sets 212 refer to organized collections of training data used by the system 114 to refine the performance of the LLM, with the data samples 214 representing smaller portions of these data sets categorized by task complexity and relevance to specific objectives.

The embeddings 216 may refer to the vectorized representations of the data samples 214, facilitating efficient processing and contextual understanding by the LLM. The embeddings are central to the system's ability to generalize across different types of tasks and user inputs. Complexity information 218 refers to the various levels of complexity associated with each task, allowing the system 114 to dynamically adjust the fine-tuning processes. For example, tasks may be categorized into low, medium, and high complexity based on the system's analysis, enabling more efficient resource allocation during training and inference phases.

The metadata 220 may contain descriptive information related to the data sets 212, the data samples 214, the embeddings 216, and the complexity information 218. The metadata 220 includes task-specific tags and complexity markers that facilitate the fine-tuning of the LLMs within system 114. The metadata 220 supports dynamic adaptation based on task difficulty and user-specific requirements, ensuring personalized output generation by the system 114. Additionally, the metadata 220 provides essential details for optimizing task handling, such as specifying relationships between data samples and associated complexity, which helps to further enhance the efficiency of the fine-tuning process.

The UI/UX module 206 may be defined as a module, which designs and manages a user interface (UI), via which the user interacts with the system 114, and the user's experience (UX) during said interaction. The UI/UX module 206 may integrate various technologies and frameworks to optimize visual layout, interactive elements, and overall usability, often utilizing principles of human-computer interaction (HCl) and graphic design.

In some examples, the UI/UX module 206 may represent one or more front-end components/interfaces 220a-220n of a chatbot that may be executed on one or more of the computing devices 102 and 104 to enable receipt of user inputs for the finetuning of the LLMs. In some examples, the user input may be received through various modalities including, but not limited to, a question input to a chat bot, a request provided through a Graphical User Interface (GUI), an email, and/or the like.

The finetuning engine 208 includes one or more processors 224, an input module 226, a token generation module 228, a characteristic module 230, an embedding module 232, a complexity module 234, a determination module 236, and a finetuning module 238.

The processor 224 may include, for example, microprocessors, digital signal processors, central processing units, or any hardware capable of executing the instructions stored in the memory to perform the fine-tuning operations. The processor 224 is configured for handling the computational aspects required to receive datasets, analyze their complexity, perform embeddings, and fine-tune the Large Language Models (LLMs). The processor 224 may fetch and execute instructions related to the creation and clustering of datasets, enabling the system 114 to adaptively sample data for efficient fine-tuning.

The input module 226 is configured to handle the reception of plurality of datasets from a variety of data sources. The plurality of datasets received by the input module 226 serve as input data for further processing, including complexity analysis and embedding. The plurality of datasets may correspond to various domains and task requirements, contributing to the diversity of data available for training the LLMs.

The token generation module 228 is configured for generating tokens from the input datasets. The token generation module 228 parses the received datasets and produces tokens which can then be embedded into vector representations. The token generation module 228 ensures that each dataset is tokenized into manageable units that retain sufficient contextual information for the subsequent embedding and fine-tuning processes.

The characteristic module 230 is designed to assess and analyze various characteristics of the datasets. This includes determining task complexity and domain complexity by analyzing the context, type, and inherent properties of the datasets. The characteristic module 230 provides the system with the ability to distinguish between tasks of varying difficulty, allowing it to perform targeted fine-tuning of LLMs based on specific dataset characteristics.

The embedding module 232 transforms the tokenized datasets into vector embeddings, mapping each token or sentence into a multi-dimensional space. The embedding module 232 employs encoding techniques such as token embeddings, sentence-level embeddings, and averaged word embeddings to generate meaningful and context-aware representations of the datasets. By encoding the datasets into vector representations, the embedding module 232 facilitates the clustering and sampling steps that are critical for optimizing the fine-tuning process of LLMs.

The complexity module 234 is configured for determining the complexity of the datasets by analyzing structure and content of the datasets. The complexity module 234 correlates the task complexity with the context and type of each dataset, allowing the system to categorize datasets based on their level of complexity. The complexity module 234 also supports the determination of which datasets are most suitable for fine-tuning, as well as for determining the appropriate embedding techniques for handling datasets of varying complexity.

The determination module 236 is configured to analyze the embeddings generated by the embedding module 232 and determines an appropriate embedded representation for the datasets based on the complexity analysis performed by the characteristic and complexity modules. The determination module 236 also facilitates the clustering of datasets into groups, enabling the system to perform focused fine-tuning of LLMs. By analyzing factors such as cluster space value, latent-space representation, and pre-learned embeddings, the determination module 236 ensures that the datasets are appropriately clustered for efficient sampling.

The fine-tuning module 238 is configured for executing the fine-tuning process of the LLMs. The fine-tuning module 238 adjusts the weights and parameters of the LLMs based on the clustered datasets and their respective complexities. The fine-tuning module 238 works in conjunction with other modules to refine the performance of LLMs by leveraging the sampled datasets and ensuring that they are fine-tuned with a focus on task-specific and domain-specific complexities.

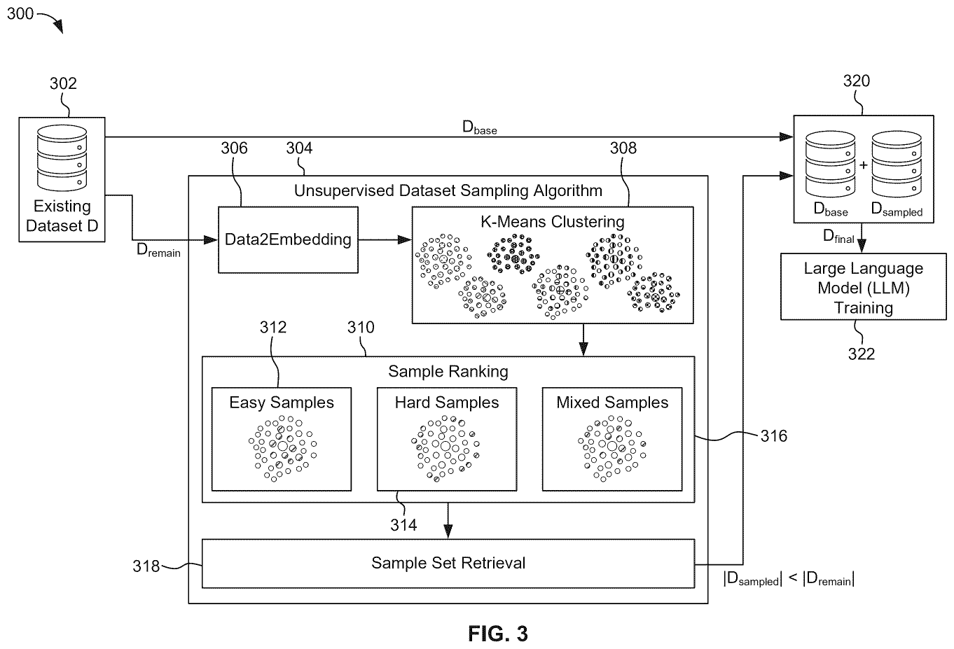

FIG. 3 depicts a block diagram showing a process flow 300 of sampling data for finetuning a plurality of large language models (LLMs) in accordance with implementations of the present disclosure. It should be noted that the reference is made to both FIG. 2 and FIG. 3 while describing the method of finetuning the LLMs.

In an embodiment of the present disclosure, upon receiving the plurality of first datasets, the input module 226 feeds the plurality of first datasets to the sampling engine 308. the extracts a plurality of base datasets from the received plurality of first datasets. The plurality of first datasets 302, also mentioned as existing dataset D, refers to an entirety of dataset used for training (previously, the entirety of the datasets was utilized for training LLMs, leading to increased costs).

In an implementation, the input module 226 uses a stratified sampling model to extract a plurality of base datasets, wherein the plurality of base datasets corresponds to a plurality of base sampled datasets present in the plurality of first datasets. The plurality of first set of datasets 302 corresponds to datasets required for training a plurality of LLMs. In some instances, the plurality of data sources may pertain to equipment or devices pertaining to a domain for which the LLM is to be implemented. For example, if the LLMs were to be trained with respect to a medical domain, the plurality of data sources may include a medical database.

Upon receiving the plurality of first datasets, the input module 226 extracts a plurality of base datasets (D_{base}) from the received plurality of first datasets. In an embodiment, the plurality of base datasets (D_{base}) is extracted/sampled based on a representative sampling technique. Representative sampling refers to a systematic sampling technique wherein a subset of data is selected in such a manner that it preserves the proportional distribution of key attributes or characteristics present in the entire dataset. This technique ensures that the sampled subset accurately reflects the diversity and distribution of the larger dataset, thereby maintaining the integrity of data representation for subsequent analysis or processing, and facilitating reliable generalization of results to the overall population. In another embodiment, the plurality of base datasets may be selected from the received plurality of the first set of datasets based on a stratified sampling technique. Stratified sampling refers to a technique of sampling that involves dividing a dataset into distinct groups or “strata” based on specific characteristics or categories. A random sample may then be taken from each group in proportion to the group's size in the overall population. This technique ensures that all significant subgroups (strata) are represented in the final sample, leading to more accurate and representative results. For example, stratified sampling might involve dividing the dataset into different task categories (e.g., text simplification, grammar correction) and then selecting samples from each category proportionally to their occurrence in a complete dataset.

Then, the system 114 determines a plurality of second datasets (Dᵣₑₘₐᵢₙ) based on the difference between the plurality of first datasets and the plurality of base datasets. Once the base datasets are identified and extracted, the system 114 processes the remaining data, referred to as the second set of datasets (Dᵣₑₘₐᵢₙ), to capture those portions of the first set of datasets that were not included in the base datasets. This determination ensures that the second set of datasets complements the base datasets by containing additional information and diversity required for further processing and subsequent optimization tasks. The second set of datasets, in conjunction with the base datasets, contributes to an enriched training set used for fine-tuning large language models (LLMs).

Then the system 114 determines a task complexity and a domain complexity (using complexity module 234) of the plurality of second datasets by analyzing a type and a context of the plurality of second datasets. The task complexity refers to a level of difficulty associated with specific tasks, characterized by factors such as a number of required operations, interdependence of subtasks, and variability of data input. The domain complexity pertains to intricacy of a subject matter or context within which a task is performed, influenced by factors such as breadth of knowledge required, diversity of concepts involved, and interrelationships among those concepts.

Specifically, the system 114 evaluates each dataset within the second set based on predefined complexity metrics, which take into account both the nature of the tasks represented in the datasets and the domains to which these tasks belong. The predefined complexity metrics may include task-based complexity metrics including label imbalance, task type, reasoning depth, context length, etc., domain specific metrics including domain-specific knowledge, vocabulary complexity, ambiguity, noise level, etc., and dataset specific metrics including annotation quality, sample diversity, etc. The type of datasets may relate to various task categories, such as text editing, simplification, or translation, while the context includes the specific conditions or nuances under which the tasks are to be performed. By considering these factors, the system 114 accurately categorizes the datasets according to their respective task and domain complexities, facilitating a more precise alignment between the dataset characteristics and the fine-tuning requirements of the large language models (LLMs). This complexity analysis ensures that the subsequent processing stages, including the selection of appropriate embedded representations and clustering, are effectively tailored to the specific demands of the datasets.

In an example, the system 114 may determine a task complexity, such that ‘text summarization’ may be a low complexity task and ‘multi-document summarization with varying topics’ may be a high complexity task. The system 114 may determine the complexity by analyzing the types of datasets used for each task, where the former typically involves a single document with straightforward content, while the latter requires the integration of multiple documents with diverse contexts and themes, thus increasing the complexity of the task.

Further, the system 114 determines the task and domain complexity by identifying one of a task having a low complexity and a task having a high complexity in a specific domain by analyzing a type and a context of the plurality of second set of datasets. For instance, in the context of text editing, a task having low complexity could involve changing the phrasing of a straightforward sentence, such as transforming “The sky is blue” to “The sky looks blue.” In contrast, a task having a high complexity may involve improving the coherence of a sentence in a longer piece of text that uses technical jargon, such as rephrasing “The methodology involves a significant amount of heterogeneity, which necessitates a comprehensive understanding of variance” to enhance clarity for a general audience.

Furthermore, the system 114 maps the identified one of the tasks having low complexity and the task having high complexity with corresponding pre-stored tasks. For example, if the task having low complexity is identified as paraphrasing a straightforward statement, the system 114 may align it with a pre-stored task designed for basic rephrasing. Conversely, if the task having high complexity involves enhancing the clarity of a technical passage, the system 114 may link to a pre-stored task focused on simplifying complex ideas into more digestible language.

Thereafter, the system 114 determines the task complexity, and the domain complexity of the plurality of the second set of datasets based on the mapping. For example, if the mapping indicates that the identified task requires restructuring a technical paragraph for clarity, the system 114 may assess complexity based on a number of edits needed, variety of sentence structures involved, and context of the editing task. This determination helps in selecting appropriate algorithms for processing the datasets and ensures that the system 114 is equipped to handle a range of editing tasks effectively, thereby improving performance on tasks that vary significantly in difficulty.

Then the system 114 determines an embedded representation for the plurality of second datasets based on a number of tasks, the determined task complexity, and the determined domain complexity, wherein the embedded representation includes feature vector representations of the plurality of second datasets. In an embodiment, the embedding module 306 the embedding module 306 analyzes feature vectors representation of the plurality of second set of datasets to ensure that the resultant embeddings capture the relevant characteristics of the data.

For instance, if the plurality of second set of datasets includes varying tasks such as text simplification, grammar correction, and coherence enhancement, the embedding module 306 may assess the complexity of each task. In a scenario where text simplification is identified as a simpler task compared to grammar correction, the embedding module 306 may generate feature vectors that reflect this disparity in complexity. Consequently, these feature vectors would provide distinct representations for each dataset, facilitating more effective downstream processing and analysis.

By utilizing the number of tasks along with their associated complexities, the embedding module 306 ensures that the resultant embedded representations are tailored to the specific characteristics and requirements of the datasets involved. This tailored approach ultimately enhances the performance of subsequent systems that rely on these embeddings for various data processing tasks.

In an embodiment, for determining the appropriate embedded representation for the plurality of second set of datasets, the embedding module 306 performs at least one of a plurality of encoding techniques. Encoding techniques refer to a set of methodologies employed to transform data into a specific format. Utilization of encoding techniques preserves essential information, and relationships present in the data while enabling compatibility with various algorithms and models for improved performance in tasks such as classification, regression, or clustering. Some examples of encoding techniques include one-hot encoding, word embeddings, sentence and document embeddings, feature encodings, positional encodings, and the like.

The plurality of encoding techniques may include at least one of a sentence-level encoding, a token embedding and an average word token embedding for the plurality of second set of datasets. The sentence-level encoding includes mapping of sentences by the embedding module 306 within the plurality of second set of datasets to a three-dimensional vector space. Alternatively, the token-embedding includes informative representations of an input sentence by the embedding module 306 for downstream tasks.

Further, the embedding module 306 correlates the task complexity, and the domain complexity of the plurality of the second set of datasets with the performed at least one of the plurality of encoding techniques. This correlation involves assessing how well each encoding technique aligns with the complexities identified. For example, if a dataset is associated with a high task complexity, the embedding module 306 may prioritize encoding techniques that are specifically designed to capture intricate relationships and nuances in the data, such as positional encodings or sophisticated embedding methods. Conversely, for datasets characterized by low task complexity, simpler encoding methods may suffice.

Furthermore, the embedding module 306 determines the performance level of each of the plurality of encoding techniques. This assessment may involve evaluating metrics such as accuracy, computational efficiency, and the ability to preserve essential data relationships. For instance, if one encoding technique consistently yields higher accuracy in subsequent machine learning tasks compared to others, it may be deemed to have a superior performance level.

Thereafter, the embedding module 306 determines the appropriate embedded representation for the plurality of second set of datasets based on the determined performance level. This selection process ensures that the chosen representation optimally balances the complexities of the task and domain while maximizing the performance capabilities of the utilized encoding techniques. As a result, the embedded representation effectively enhances the data sets'utility for subsequent processing steps, improving overall outcomes in tasks such as classification, regression, or clustering.

Upon generating the embeddings, a clustering module 308 of the sampling engine 304 generates a plurality of clustered datasets by clustering the embedded representation of the plurality of second datasets into a plurality of clustered datasets based on a cluster space value, a latent-space representation, and pre-learnt embedding spaces. The plurality of clusters corresponds to the number of tasks to be performed.

The cluster space value refers to a quantitative measure that characterizes the distribution and proximity of data points within a specific cluster in a multi-dimensional space. This value is derived from clustering algorithms, which group similar data points based on defined features. The cluster space value aids in evaluating the cohesion of the cluster and can be utilized to compare the effectiveness of various clustering techniques. For example, a lower cluster space value indicates a tighter grouping of data points, suggesting higher similarity among them.

The latent-space representation is a lower-dimensional embedding of data that captures the underlying patterns and structures within the dataset while reducing its complexity. This representation is generated through various machine learning techniques, such as autoencoders or generative models, which learn to encode the data in a latent space by identifying essential features and relationships. Latent-space representations facilitate tasks such as data visualization, anomaly detection, and generative modeling by enabling the exploration of complex data in a simplified form, thereby preserving significant information.

The pre-learnt embedding spaces refer to embedding representations that have been previously established through training on a substantial dataset before being applied to new, unseen data. These embedding spaces are created using techniques such as word embedding or sentence embedding, where the relationships between data points are captured in a fixed-dimensional vector space. Pre-learnt embedding spaces allow for improved performance in downstream tasks, as they leverage learned representations that encapsulate semantic meaning and contextual information from the original dataset. For example, word embeddings such as Word2Vec or GloVe serve as pre-learnt embedding spaces that enhance the performance of natural language processing tasks.

The plurality of clusters corresponds to the number of tasks to be performed by the clustering module 308, ensuring a structured approach to task management and execution. Each cluster encapsulates a set of data points that share similar characteristics or features, allowing the clustering module 308 to effectively categorize and prioritize tasks based on their inherent properties. For instance, if the clustering module 308 identifies four distinct clusters, this suggests the existence of four separate tasks, such as classifying customer reviews, detecting fraudulent transactions, analyzing sensor data, or predicting user behavior. Each task is uniquely aligned with the specific attributes of its corresponding cluster, which enables the clustering module 308 to tailor its processing techniques accordingly. This clustering approach not only enhances the accuracy of the task performance but also optimizes resource allocation by focusing on the most relevant datasets associated with each task. Exemplary representations of such clusters are depicted in FIG. 3 along with the clustering module 308.

In some instances, for creating the plurality of clustered datasets, the clustering module 308 determines the plurality of tasks to be performed based on the determined embedded representation for the plurality of second set of datasets. This involves analyzing the embedded representations, which encapsulate essential features of the datasets, to identify specific tasks that can be executed efficiently. The clustering module 308 evaluates various characteristics of the embedded data to determine the most relevant tasks for processing.

The plurality of tasks may include but are not limited to a text editing, a language translation, a speech to text conversion and an image processing, language processing, answering questions, image editing, video editing, and building/editing software/any type of content. Text editing refers to modification of written content to enhance its clarity, coherence, grammar, and overall quality. This may involve activities such as proofreading, formatting, and making stylistic changes to improve the readability and effectiveness of the text.

Language translation refers to the conversion of text or speech from one language to another while preserving the original meaning and context. This necessitates an understanding of cultural nuances and idiomatic expressions to ensure that translations are accurate and contextually appropriate. Speech-to-Text conversion involves transforming spoken language into written text using speech recognition technology. This is vital for applications such as transcription services and voice command interfaces, allowing for the seamless conversion of audio input into written form.

Image processing is the manipulation and analysis of digital images to enhance or extract information. It may encompass various techniques, including filtering, segmentation, and feature extraction, aimed at improving image quality or analyzing visual content for specific applications. Language processing pertains to computational handling of human language data, which includes tasks such as natural language understanding and natural language generation. This focuses on enabling computers to understand, interpret, and respond to inputs in human language effectively.

Answering questions is an ability to retrieve relevant information and provide accurate responses to user inquiries. This often involves employing information retrieval techniques, natural language understanding, and contextual analysis to ensure that the answers are pertinent and reliable. Image editing refers to the alteration or enhancement of images through software tools to achieve a desired visual effect. This may include cropping, color correction, and applying various filters, all aimed at improving the overall appearance and quality of the image.

Video editing is the process of manipulating and rearranging video footage to create a new work. This includes tasks such as cutting and splicing clips, adding effects, and adjusting audio elements to produce a polished and cohesive final product. Building/Editing software involves the development and modification of software applications to incorporate new features, fix bugs, or improve functionality. This requires programming knowledge and familiarity with various software development methodologies and practices. Creating any type of content encompasses generation of diverse forms of content, including written articles, graphics, videos, and interactive media. This emphasizes creativity and the effective communication of information across various formats to engage and inform audiences.

Further, the clustering module 308 determines relevance of the plurality of second set of datasets with the determined plurality of tasks to be performed. This determination is achieved by analyzing various attributes of the datasets, such as their content, context, and characteristics, to ascertain their applicability to specific tasks like language translation or image processing. For example, if the identified tasks include text editing and speech-to-text conversion, the clustering module 308 evaluates datasets containing textual data for text editing and audio data for speech-to-text conversion. This relevance assessment ensures that only the datasets with a high degree of alignment to the identified tasks are selected, thereby enhancing the efficiency and effectiveness of subsequent processing steps. By prioritizing datasets that significantly contribute to task execution and filtering out irrelevant or low-relevance data, the clustering module 308 improves overall system performance and reduces potential distractions during processing.

Furthermore, the clustering module 308 clusters the determined embedded representation for the plurality of second set of datasets, based on the determined plurality of tasks and the determined relevancy. In this regard, the clustering module 308 employs clustering algorithms to group datasets into distinct clusters, with each cluster representing a specific task aligned with the relevance evaluation. For instance, if the tasks include language processing and image editing, the clustering module 308 may create one cluster containing datasets relevant to language processing tasks, such as articles or reports, and another cluster for datasets pertinent to image editing, such as photographs or graphics. This organized clustering facilitates efficient processing by structuring the datasets in a manner that directly corresponds to the tasks to be executed. Consequently, this optimization enhances resource allocation and workflow management, allowing the system to access the most relevant datasets quickly and efficiently.

Thereafter, the clustering module 308 creates the plurality of clustered datasets based on the clustering. The resulting clustered datasets include well-organized subsets of the original datasets, with each subset specifically corresponding to a designated task. For example, a clustered datasets set for image processing may include only those datasets that pertain to image files and related metadata. This structured data enables the system to proceed with further processing and analysis effectively, ensuring that the execution of the identified tasks is streamlined. By leveraging this organized approach, the clustering module 308 facilitates improved accuracy and performance in achieving task objectives, as it allows the system to focus on relevant data without unnecessary distractions.

Upon creating the clusters, a sampling module 310 of the sampling engine 304 samples the created plurality of clustered datasets. The sampling module 310 samples the plurality of clustered datasets by determining sampling weights of the plurality of clustered datasets to generate a plurality of types of samples. The determination of sampling weights involves analyzing the characteristics and distribution of data points within each cluster, using the centroid value as a reference. The centroid value serves as a central point for each cluster, representing the average position of all data points in the feature space, thus providing insights into the overall structure and density of the clustered datasets.

The sampling module 310 determines sampling weights of the plurality of clustered datasets based on a centroid value. The centroid value represents a calculated central point or mean of a cluster within the clustered datasets, serving as a reference for evaluating the distribution and characteristics of the data points in that cluster. By utilizing the centroid, the sampling module 310 assesses how closely individual data points align with the central characteristics of their respective clusters. Data points that are situated closer to the centroid are assigned higher weights, indicating their greater relevance and representativeness within the cluster. This weighting mechanism ensures that the sampling process prioritizes more significant and relevant data, ultimately enhancing the accuracy and effectiveness of the samples generated.

The plurality of types of samples includes at least one of samples having a low complexity 312, samples having a medium complexity 316, and samples having a high complexity 314. This stratified sampling approach allows the sampling module 310 to produce a variety of samples that cater to different analytical needs. Low complexity samples 312 may include straightforward data points suitable for basic analyses, while medium complexity samples 316 can represent more nuanced datasets, and high complexity samples 314 may encompass intricate datasets requiring advanced processing capabilities. By creating a diverse set of samples, the sampling module 310 enables the overall system 114 to effectively tackle a wide range of tasks, thereby optimizing resource allocation and enhancing performance across various applications.

In some instances, for sampling the created plurality of clustered datasets, the sampling module 310 determines a distance between the created plurality of clustered datasets and the centroid value of a corresponding cluster in a latent space. The centroid value, which represents the average position of all data points within a specific cluster, serves as a reference point for evaluating the distribution of data within that cluster. By calculating this distance, the sampling module 310 assesses how well each data point in the cluster aligns with the central characteristics defined by the centroid. This analysis aids in identifying which data points are more representative of the cluster's overall structure and enables more informed sampling decisions.

Further, the sampling module 310 generates the plurality of types of samples based on the determined distance between the created plurality of clustered datasets and the centroid value. This allows for the categorization of samples according to their proximity to the centroid, enabling the creation of diverse sample types that reflect varying levels of complexity. For instance, samples that are closer to the centroid may be classified as having lower complexity, while those that are further away may be associated with higher complexity.

Furthermore, the sampling module 310 determines a behavioural pattern for the generated plurality of types of samples based on the tasks associated with plurality of clustered datasets. By analyzing the relationships between the tasks and the characteristics of the samples, the sampling module 310 can identify trends and behaviors inherent to the sampled data. This behavioral analysis further informs the selection and prioritization of samples for subsequent processing and analysis.

Thereafter, the sampling module 310 ranks each of the generated plurality of types of samples based on a proximity level of the determined distance towards the centroid value and the determined behavioural pattern. This ranking enables the clustering module 308 to prioritize samples that are not only representative of their respective clusters but also relevant to the associated tasks. By focusing on samples that exhibit significant alignment with the centroid and the identified behavioral patterns, the sampling module 310 enhances the efficacy and relevance of the sampled data for further processing.

A sample retrieval module 318 of the sampling engine 304 determines a plurality of appropriate samples from the generated plurality of types of samples. The sample retrieval module 318 evaluates the generated samples based on predefined criteria such as relevance, diversity, and representation of various task complexities. By applying algorithms that assess the suitability of each sample for the intended application, the sample retrieval module 318 ensures that only the most pertinent and high-quality samples are selected for further processing. This selection is critical for optimizing the performance of subsequent stages in the system 114.

Thereafter, the system 114 performs fine tuning of the plurality of LLMs based on the extracted plurality of base datasets and the determined plurality of appropriate samples. Fine-tuning involves adjusting the parameters of the LLMs to improve their performance on specific tasks by exposing them to the selected samples and corresponding datasets. This enhances the LLM's ability to generate more accurate and contextually relevant outputs, thereby aligning the LLM's responses more closely with the requirements of the tasks it is intended to perform.

In an embodiment, the system 114 performs the fine tuning of the plurality of LLMs by training the plurality of LLMs using a subset of the plurality of the first set of datasets received from the plurality of data sources and the determined plurality of appropriate samples. The training utilizes a targeted subset that represents the second set of datasets, which is specifically curated to capture essential characteristics and complexities associated with the tasks identified during the sampling process. By integrating this curated data with the appropriate samples, the system 114 is capable of refining the LLMs more effectively, allowing for improved generalization and performance across various applications.

The subset of the plurality of the first set of datasets corresponds to plurality of second set of datasets. This correspondence ensures that the fine-tuning process leverages the most relevant and representative data, facilitating the LLMs' adaptation to the nuances of the task at hand. By maintaining this alignment between the datasets and the tasks, the system 114 enhances the overall accuracy and efficiency of the models in practical scenarios.

In another embodiment, the system 114 performs the fine tuning of the plurality of LLMs by determining a distance between the extracted plurality of base datasets and the determined plurality of appropriate samples with a centroid value. This distance measurement involves calculating how closely the base datasets align with the selected samples, using the centroid as a reference point. The centroid represents the average position of all relevant data points within the feature space, providing a benchmark for assessing the similarity and relevance of the datasets to the samples. By quantifying this distance, the system 114 can evaluate the degree of alignment between the datasets and samples, which is critical for ensuring that the models are trained on the most pertinent information.

Further, the system 114 determines appropriate hyperparameter values associated with each of the plurality of LLMs based the determined distance. Hyperparameters play a crucial role in controlling the learning process of the LLMs, influencing aspects such as learning rate, batch size, and the number of training epochs. By leveraging the distance metrics, the system can optimize these hyperparameters to enhance the training process. Specifically, a smaller distance may indicate that the corresponding datasets and samples are closely aligned, suggesting the need for fine-tuning with specific hyperparameter configurations to maximize performance. Conversely, a larger distance may necessitate adjustments to the hyperparameters to improve the model's adaptability to the diverse characteristics of the training data.

Furthermore, the system 114 determines an appropriate LLM for training based on the determined appropriate hyperparameter values. This selection involves assessing the capabilities and architecture of various LLMs to identify the most suitable candidate for the current training objectives. Factors such as the LLM's size, structure, and performance on similar tasks are considered, ensuring that the chosen LLM can effectively leverage the curated datasets and samples for fine-tuning. This targeted approach enhances the likelihood of achieving optimal performance and generalization in the final model.

Thereafter, the system 114 performs fine tuning of the determined appropriate LLM based on the extracted plurality of base datasets and the determined plurality of appropriate samples. This focuses on refining the LLM's parameters to improve its performance on specific tasks. By incorporating the previously calculated distances and hyperparameter adjustments, the training process becomes more efficient and effective. The result is an LLM that is better equipped to handle the nuances of the data, leading to improved accuracy and relevance in its outputs across a range of applications.

In some instances, the system 114 generates a plurality of fine-tuned output prompts from each of the fine-tuned plurality of LLMs corresponding to the received plurality of first set of datasets. This generation involves utilizing the contextual understanding and knowledge encapsulated within each fine-tuned LLM to create output prompts tailored to the specific requirements of the input datasets. By leveraging the unique characteristics of each model, the system 114 can produce diverse prompts that reflect different perspectives or insights relevant to the datasets. This capability enables the system 114 to enhance user interaction by offering a range of generated prompts that cater to various user needs, thereby improving the overall utility and responsiveness of the system 114.

Thereafter, the system 114 outputs the generated plurality of fine-tuned output prompts on a user interface of a user device. This includes presenting the prompts in a user-friendly format, possibly via the UI/UX module 206, ensuring that they are easily accessible and comprehensible to the end-user. The user interface may feature interactive elements that allow users to select, modify, or further refine the output prompts according to their specific use cases. By providing a seamless interface, the system 114 enhances user engagement and facilitates effective interaction with the generated prompts, ultimately driving improved outcomes in user-driven tasks.

In an embodiment, the system 114 computes at least one evaluation measure for the plurality of fine-tuned LLMs. Evaluation measures serve as quantitative metrics that assess the performance and effectiveness of each fine-tuned LLM based on predetermined criteria. These measures may include accuracy, precision, recall, F1 score, or other relevant statistical metrics tailored to the specific applications of the LLMs. By systematically calculating these evaluation measures, the system 114 gains insights into the strengths and weaknesses of each model, enabling informed decision-making regarding their usage.

Further, the system 114 evaluates a performance of the plurality of fine-tuned LLMs based on the at least one evaluation measure. This evaluation entails a comparative analysis of the computed measures against benchmark standards or baseline performances established during previous training or testing phases. By conducting this performance evaluation, the system 114 can identify which fine-tuned LLMs meet or exceed performance expectations, as well as those that may require further optimization or adjustment. This step is crucial for ensuring that the models deployed in production settings deliver high-quality outputs that align with user requirements.

Furthermore, the system 114 determines at least one appropriate LLM to be fine-tuned based on the results of evaluation. This determination involves analyzing the evaluation outcomes to identify models that demonstrate significant potential for further enhancement. The system 114 may prioritize LLMs that exhibit promising results in specific areas, such as accuracy or response coherence, and focus on refining these models through additional training or adjustments. By strategically selecting appropriate LLMs for fine-tuning, the system 114 aims to continuously improve its performance capabilities, ensuring that users benefit from the most effective and reliable language models available.

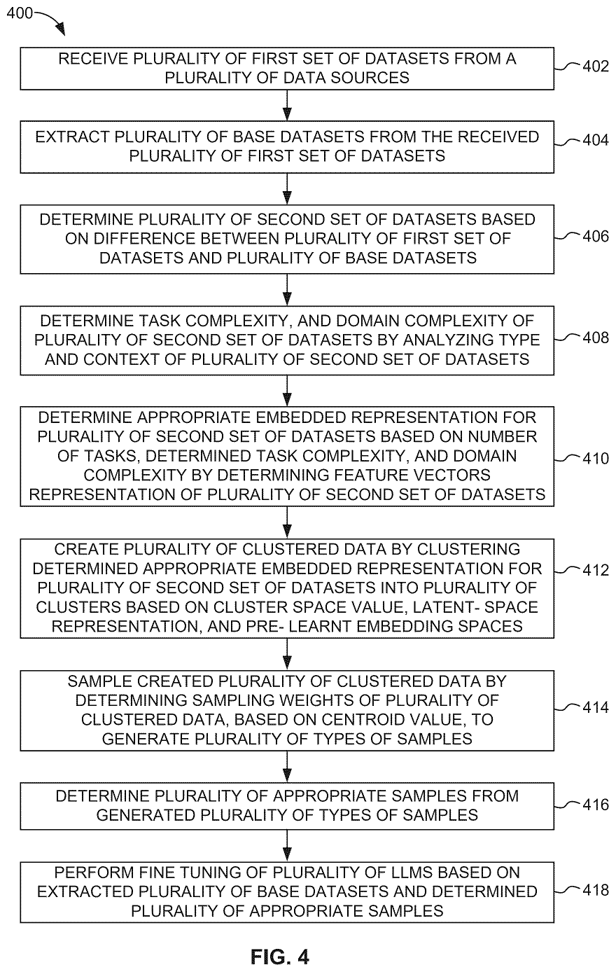

FIG. 4 illustrates a flow diagram depicting an exemplary method 400 in accordance with implementations of the present disclosure.

At step 402, a plurality of first datasets is received from various data sources. These datasets may encompass diverse formats essential for the effective training of LLMs. Data sources may include online databases, public repositories, and proprietary enterprise datasets. For example, datasets could be sourced from academic journals, social media platforms, and e-commerce sites, ensuring a rich variety of data for comprehensive model training. By leveraging diverse datasets, the method 400 may enhance robustness of the LLMs, thereby improving their ability to generalize across a multitude of tasks.

At step 404, a plurality of base datasets is extracted from the received datasets. The extraction may involve identifying representative samples for model training. It will be appreciated that the plurality of base datasets is not extracted randomly and instead is extracted with respect to underlying patterns in the data. This may ensure that the extracted datasets encapsulate relevant patterns and relationships present in the original datasets, thus laying a solid foundation for subsequent analysis and model development. This step is crucial for maintaining the balance between data quantity and quality, ensuring that the models can learn effectively without being overwhelmed by excessive noise.

At step 406, a plurality of second datasets is determined based on the differences between the first datasets and the base datasets. This step may involve analyzing variations to understand underlying complexities and nuances present in the data. The plurality of second datasets may be determined based on remaining datapoints, which may not have been covered or included in the plurality of base datasets.

At step 408, task complexity and domain complexity of the second datasets are assessed. This may involve evaluating the type and context of each dataset, considering factors such as data volume, feature diversity, and inherent relationships. For instance, a dataset pertaining to sentiment analysis might exhibit varying complexity based on the range of sentiments expressed, which directly impacts how LLMs interpret and generate text. This detailed assessment ensures that LLMs can dynamically adapt their outputs based on the specific demands of each task.

At step 410, an appropriate embedded representation for the second plurality of datasets is determined. This may be achieved by calculating feature vectors that effectively represent the datasets based on the number of tasks, task complexity, and domain complexity. Utilizing various data processing algorithms, such as clustering algorithms, dimensionality reduction techniques, and regression models, facilitates a deeper understanding of the data landscape. The choice of algorithms is essential in refining how models perceive and handle complex data relationships, further enhancing the LLMs' performance.

At step 412, a plurality of clustered data is created by clustering the determined embedded representations of the second datasets. This clustering may be based on multiple dimensions, including cluster space values and semantic similarities, ensuring that semantically related data points are represented closer together in the latent space. For example, datasets with similar contexts or complexities are grouped to enhance the efficiency of the model training process. This ensures that LLMs are exposed to coherent data patterns, allowing for improved learning and adaptation.

At step 414, sampling weights are determined for the clustered data to generate various types of samples. The types of samples may include various complexities, including low complexity, medium complexity, and high complexity. By employing statistical sampling techniques, such as stratified sampling and importance sampling, the method 400 may ensure a balanced representation of data, which is essential for effective model training. This targeted sampling allows for a more nuanced approach to LLM training, enabling models to better understand the range of tasks they will encounter.

At step 416, appropriate samples are selected from the generated sample types. This selection may be performed based on predefined criteria to ensure that the samples encompass a diverse and representative distribution of the data. By carefully curating the samples, the method 400 enhances the model's ability to generalize across different tasks and domains, directly addressing the challenges posed by current LLMs in personalizing outputs based on varying user inputs.

At step 418, fine-tuning of the LLMs is conducted based on the extracted base datasets and the determined appropriate samples. This fine-tuning may involve adjusting model parameters and optimizing performance metrics, ensuring that the LLMs are tailored to the specific characteristics of the datasets they are trained on. This not only improves the model's accuracy but also enhances its responsiveness to individual user intents, effectively bridging a gap between human-defined complexity and the LLM's learning capabilities.

The advantages of the present technology include improved adaptability and accuracy in training LLMs through the systematic extraction and sampling of relevant datasets. This method 400 ensures that models are trained on a representative set of data, which enhances their capability to handle complex tasks and domains effectively. As a result, LLMs can generate more precise and contextually relevant outputs, effectively addressing the challenge of personalizing responses to diverse user intents.

The approach allows for enhanced personalization by utilizing a diverse range of datasets, which addresses the limitation of existing LLMs that often rely on generalized responses. By employing a systematic clustering and sampling technique, the method 400 enables LLMs to interpret and respond to nuanced differences in user commands more effectively. This adaptability significantly improves user interaction and satisfaction, making the models more efficient in real-world applications.

Additionally, the technology demonstrates practical applications through its ability to dynamically adapt to varying dataset complexities. The fine-tuning process allows LLMs to remain responsive to shifts in data characteristics, ensuring sustained performance across different use cases. This adaptability is crucial for meeting the demands of evolving applications, from natural language processing to domain-specific knowledge tasks, thereby enhancing the effectiveness and resilience of the models in handling new challenges.

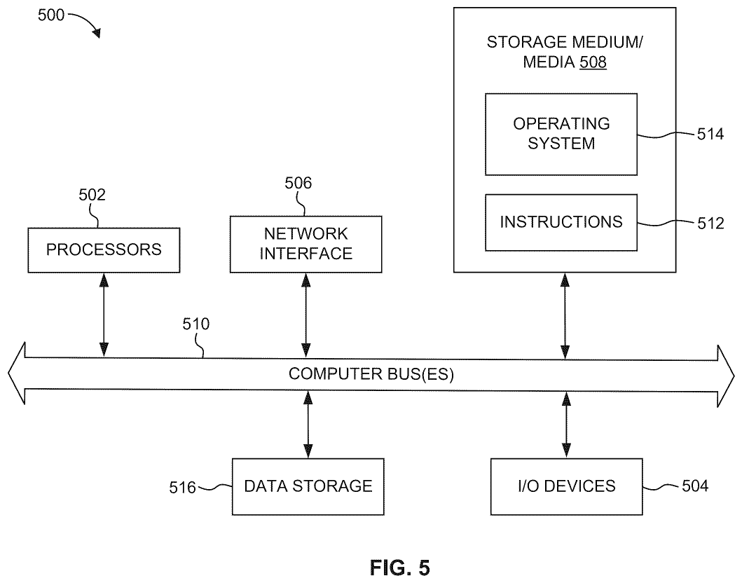

FIG. 5 illustrates a computer system 500 that may be used to implement the system 114. More particularly, computing machines such as desktops, laptops, smartphones, tablets, and wearables which may be used to process the conversational interactions in the system 114 may have the structure of the computer system 500. The computer system 500 may include additional components not shown and that some of the process components described may be removed and/or modified. In another example, a computer system 500 may be deployed on external-cloud platforms such as cloud, internal corporate cloud computing clusters, organizational computing resources, and/or the like.

The computer system 500 includes processor(s) 502, such as a central processing unit, ASIC or another type of processing circuit, input/output devices 504, such as a display, mouse keyboard, etc., a network interface 506, such as a Local Area Network (LAN), a wireless 902.11x LAN, a 3G or 4G mobile WAN or a WiMax WAN, and a processor-readable medium 508. Each of these components may be operatively coupled to a bus 510.

The computer-readable medium 508 may be any suitable medium that participates in providing instructions to the processor(s) 502 for execution. For example, the computer-readable medium 508 may be non-transitory or non-volatile medium, such as a magnetic disk or solid-state non-volatile memory or volatile medium such as RAM. The instructions or modules stored on the computer-readable medium 508 may include machine-readable instructions 512 executed by the processor(s) 502 that cause the processor(s) 502 to perform the methods and functions of the system 114.

The system 114 may be implemented as software stored on a non-transitory processor-readable medium and executed by the processors 502. For example, the computer-readable medium 508 may store an operating system 514, such as MAC OS, MS WINDOWS, UNIX, or LINUX, and code for the system 114. The operating system 514 may be multi-user, multiprocessing, multitasking, multithreading, real-time, and the like. For example, during runtime, the operating system 514 is running and the code for the system 114 is executed by the processor(s) 502.

The computer system 500 may include a data storage 516, which may include non-volatile data storage. The data storage 516 stores any data used or generated by the system 114. The network interface 506 connects the computer system 500 to internal systems for example, via a LAN. Also, the network interface 506 may connect the computer system 500 to the Internet. For example, the computer system 500 may connect to web browsers and other external applications and systems via the network interface 506.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations of the present disclosure provide substantial benefits by employing a systematic approach to sampling datasets that encompass varied complexities, including low complexity, medium complexity, and high complexity. This strategic sampling ensures that Large Language Models (LLMs) are exposed to a diverse range of task complexities during training, which enhances their ability to generate contextually relevant responses tailored to individual user needs. For instance, low complexity tasks may involve straightforward inquiries, while high complexity tasks could encompass nuanced requests requiring deeper understanding and contextual awareness. By utilizing this varied sampling methodology, the inventive step improves the models' adaptability and responsiveness, resulting in heightened user satisfaction and engagement across a variety of applications, from customer service chatbots to advanced analytical tools.

Furthermore, optimization of the training of LLMs leads to substantial efficiency gains and reduced resource utilization. By strategically leveraging a focused dataset that represents a range of complexities, the system significantly minimizes the volume of data required for effective training, thereby reducing computational costs and processing times. This streamlined approach not only enhances operational efficiency but also supports a more accurate and dynamic determination of task complexity based on the inherent characteristics of the LLMs rather than relying on potentially subjective human-defined complexity measures. As a result, organizations can achieve greater cost-effectiveness, improve the personalization of outputs, and facilitate a more responsive and adaptable LLM that meets diverse user needs while maintaining high performance levels.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them.

The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system 914, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system.

A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include or be operatively coupled to receive data from or transfer data to, or both, one or more mass storage devices for storing data (e.g., magnetic, magneto optical disks, or optical disks).

However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media, and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in a generic classical processor system and a quantum computing system.

While this specification contains many specific implementation details, these should not be construed as limitations on the scope of what may be claimed, but rather as descriptions of features that may be specific to particular implementations. Certain features that are described in this specification in the context of separate implementations can also be implemented in combination with a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together into a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive a plurality of first datasets from a plurality of data sources, wherein the plurality of first datasets correspond to training datasets for training a plurality of Large Language Models (LLMs);
extract a plurality of base datasets from the received plurality of first datasets using a stratified sampling model, wherein the plurality of base datasets corresponds to a plurality of base sampled datasets present in the plurality of first datasets;
determine a plurality of second datasets based on the difference between the plurality of first datasets and the plurality of base datasets;
determine a task complexity and a domain complexity of the plurality of second datasets by analyzing a type and a context of the plurality of second datasets, wherein the task complexity comprises a level of difficulty based on a number of required operations and interdependence of subtasks, and wherein the domain complexity comprises an intricacy level of subject matter based on breadth of knowledge required and interrelationships among concepts;
determine an embedded representation for the plurality of second datasets based on a number of tasks, the determined task complexity, and the determined domain complexity, wherein the embedded representation comprises feature vector representations of the plurality of second datasets;
generate a plurality of clustered datasets by clustering the embedded representation of the plurality of second datasets into a plurality of clusters based on a cluster space value, a latent-space representation, and pre-learnt embedding spaces, wherein the plurality of clusters correspond to the number of tasks to be performed;
generate a plurality of sampled datasets by sampling the plurality of clustered datasets based on sampling weights and distances to a centroid value of each cluster, wherein the plurality of sampled datasets comprise data samples with a specific complexity value being proximate and distant to the centroid value, and wherein the sampling weights control a proportion of the specific complexity value;
select appropriate data samples from the generated plurality of sampled datasets based on the sampling weights and the distances to the centroid value of each cluster;
perform fine-tuning of the plurality of LLMs using the extracted plurality of base datasets and the selected plurality of sampled datasets, wherein the fine-tuning comprises adjusting model hyper parameters of the plurality of LLMs;
generate a plurality of fine-tuned output prompts from each of the fine-tuned plurality of LLMs based on the received plurality of first datasets; and
output the generated plurality of fine-tuned output prompts on a user interface of a user device, wherein the output prompts being personalized based on user-specific intents derived from the domain complexity and the task complexity.

2. The system of claim 1, wherein to determine the task complexity and the domain complexity of the plurality of second datasets by analyzing the type and the context of the plurality of second datasets, the processor is to:
evaluate each dataset within the plurality of second datasets based on predefined complexity metrics corresponding to nature of tasks and related domains, wherein the predefined complexity metrics comprise a task operation count metric, a subtask interdependence metric, a data variability metric, a domain knowledge breadth metric, and a concept interrelationship metric;
identify at least one task in a specific domain by analyzing the type and the context of the plurality of second datasets, wherein the at least one task comprises at least one of a first complexity level comprising simple tasks and a second complexity level comprising complex interdependent subtasks with variability, and wherein the context comprises specific conditions for performing the tasks, and wherein the type of dataset corresponds to a plurality of task categories comprising at least one of a text editing, a simplification, and a translation;
map the identified at least one task to a plurality of pre-stored tasks in a database, wherein the identified at least one task being correlated to hierarchical relationships, specific knowledge requirements, and diversity of concepts within the domain; and
determine the task complexity and the domain complexity of the plurality of second datasets based on the mapping and results of evaluation.

3. The system of claim 1, wherein to determine the embedded representation for the plurality of second datasets based on the number of tasks, the determined task complexity, and the determined domain complexity, the processor is to:
generate the feature vector representations indicating a plurality of complexity characteristics relevant to the tasks and the domain, wherein the plurality of complexity characteristics comprise variations and types in task complexity;
encode the plurality of second datasets using at least one of a sentence-level encoding, a token embedding, and an averaged word token embedding, wherein the sentence-level encoding maps sentences to a multi-dimensional vector space using a pre-trained encoder model, the token embedding comprises representations of each datasets for downstream tasks, and wherein the averaged word token embedding computes an average of word embeddings for sentence-level representation to aggregate token-level features;
correlate the task complexity and the domain complexity with the encoded plurality of second datasets based on the number of tasks and domain-specific requirements to determine alignment with the plurality of complexity characteristics;
determine a performance level of each of the sentence-level encoding, the token embedding and the averaged word token embedding based on a clustering accuracy, a separation of task-related data, and data relationships, wherein the performance level being assessed based on a cohesion score to evaluate cohesion within the plurality of clusters and separation between the plurality of clusters; and
determine an appropriate embedded representation for the plurality of second datasets based on the determined performance level.

4. The system of claim 1, wherein to generate the plurality of clustered datasets by clustering the embedded representation of the plurality of second datasets into the plurality of clusters based on the cluster space value, the latent-space representation, and the pre-learnt embedding spaces, the processor is to:
determine a plurality of tasks to be performed based on the embedded representation of the plurality of second datasets, wherein the plurality of tasks comprises at least one of text editing, language translation, speech-to-text conversion, image processing, language processing, question answering, image editing, video editing, software content generation and content modification, and wherein the plurality of tasks being determined by analyzing latent patterns in the embedded representation to identify a plurality of task categories;
determine a relevance of the plurality of second datasets to the determined plurality of tasks by analyzing semantic similarities and applicability, wherein the relevance being assessed using a cosine similarity value between dataset embeddings and task-specific pre-learned embedding spaces;
cluster the embedded representation using the AI based clustering model based on the determined plurality of tasks and the determined relevance, wherein the clustering embeds the cluster space value to evaluate distribution and proximity of data points within each cluster, and wherein the clustering being evaluated using a cohesion score to derive an optimal number of clusters corresponding to the number of tasks; and
generate the plurality of clustered datasets based on the clustering, wherein each cluster represents a category of task-related knowledge.

5. The system of claim 1, wherein the processor is to:
compute at least one text evaluation metric for the plurality of fine-tuned LLMs, wherein the at least one text evaluation metric comprises quantitative measures of text generation and text modification, operation evaluation metrics, and similarity metrics;
evaluate a performance of the plurality of fine-tuned LLMs based on the at least one text evaluation metric, wherein the plurality of fine-tuned LLMs being compared to baseline models to determine an accuracy level, a coherence level, and a task-specific effectiveness level; and
select at least one LLM for subsequent fine-tuning based on results of evaluation.

6. The system of claim 1, wherein to generate the plurality of sampled datasets by sampling the plurality of clustered datasets based on the sampling weights and the distances to the centroid value of each cluster, the processor is to:
determine a cosine distance between each data point in the plurality of clustered datasets and the centroid value of a corresponding cluster in the latent space, wherein the centroid value represents an average position of data points within the cluster, and wherein the cosine distance represents proximity to evaluate sample complexity;
generate the plurality of types of samples based on the determined cosine distance, wherein the plurality of types of samples being categorized as at least one of a low complexity indicating closeness to the centroid value and representativeness of core cluster knowledge, a medium complexity for intermediate distances, and a high complexity for maximum distances indicating complex tasks at a cluster periphery;
determine a behavioral pattern for the generated plurality of types of samples based on tasks associated with the plurality of clustered datasets, wherein the behavioral pattern identifies trends in task generalization and semantic similarities across samples; and
rank each of the generated plurality of types of samples based on a proximity level of the determined cosine distance to the centroid value and the determined behavioral pattern.

7. The system of claim 1, wherein to perform fine-tuning of the plurality of LLMs using the extracted plurality of base datasets and the selected plurality of sampled datasets, the processor is to:
train the plurality of LLMs in a specific sequence based on the task complexity and the domain complexity using a subset of the plurality of the first datasets and the selected plurality of samples, wherein the subset of the plurality of the first datasets corresponds to plurality of second set of datasets.

8. The system of claim 1, wherein to perform the fine-tuning of the plurality of LLMs using the extracted plurality of base datasets and the selected plurality of sampled datasets, the processor is to:
determine a distance between the extracted plurality of base datasets and the selected plurality of samples relative to the centroid value, wherein the distance being computed using a cosine similarity value;
determine the model hyperparameter values associated with each of the plurality of LLMs based on the determined distance, wherein the model hyperparameter values comprise at least one of a learning rate, a batch size, a number of training epochs, and the sampling weights;
select an LLM for fine-tuning based on the determined model hyperparameter values and compatibility with domain-specific pre-training data, wherein the selection prioritizes the plurality of LLMs with pre-existing knowledge aligned to the task complexity and the domain complexity; and
perform the fine-tuning of the selected LLM using the extracted plurality of base datasets and the selected plurality of samples, wherein the fine-tuning comprises adjusting the model hyper parameters, applying early stopping upon a predefined number of epochs, and adapting the LLM for personalized outputs based on the user intents.

9. The system of claim 8, wherein to determine the model hyper parameter values associated with each of the plurality of LLMs based on the determined distance, the processor is to:
identify task-specific characteristics and domain-specific characteristics by analyzing a domain knowledge derived from the plurality of second datasets, wherein the domain knowledge comprises semantic patterns and hierarchical relationships relevant to the tasks;
evaluate a cohesion level within the plurality of clusters and the distance between the plurality of clusters in the embedded representation of the plurality of second datasets by computing a clustering quality metric, wherein the clustering quality metric determines an optimal number of clusters corresponding to the number of tasks;
determine optimal sampling weights based on the clustering quality metric and the domain knowledge, wherein sampling weights control a proportion of complexity samples being proximate and distant to the centroid value; and
determine appropriate model hyper parameter values associated with each of the plurality of LLMs based on the determined optimal sampling weights and the evaluated cohesion level.

10. A method comprising:
receiving, by a processor, a plurality of first datasets from a plurality of data sources, wherein the plurality of first datasets correspond to training datasets for training a plurality of Large Language Models (LLMs);
extracting, by the processor, a plurality of base datasets from the received plurality of first datasets using a stratified sampling model, wherein the plurality of base datasets corresponds to a plurality of base sampled datasets present in the plurality of first datasets;
determining, by the processor, a plurality of second datasets based on the difference between the plurality of first datasets and the plurality of base datasets;
determining, by the processor, a task complexity and a domain complexity of the plurality of second datasets by analyzing a type and a context of the plurality of second datasets, wherein the task complexity comprises a level of difficulty based on a number of required operations and interdependence of subtasks, and wherein the domain complexity comprises an intricacy level of subject matter based on breadth of knowledge required and interrelationships among concepts;
determining, by the processor, an embedded representation for the plurality of second datasets based on a number of tasks, the determined task complexity, and the determined domain complexity, wherein the embedded representation comprises feature vector representations of the plurality of second datasets;
generating, by the processor, a plurality of clustered datasets by clustering the embedded representation of the plurality of second datasets into a plurality of clusters based on a cluster space value, a latent-space representation, and pre-learnt embedding spaces, wherein the plurality of clusters correspond to the number of tasks to be performed;
generating, by the processor, a plurality of sampled datasets by sampling the plurality of clustered datasets based on sampling weights and distances to a centroid value of each cluster, wherein the plurality of sampled datasets comprise data samples with a specific complexity value being proximate and distant to the centroid value, and wherein the sampling weights control a proportion of the specific complexity value;
selecting, by the processor, appropriate data samples from the generated plurality of sampled datasets based on the sampling weights and the distances to the centroid value of each cluster;
performing, by the processor, fine-tuning of the plurality of LLMs using the extracted plurality of base datasets and the selected plurality of sampled datasets, wherein the fine-tuning comprises adjusting model hyper parameters of the plurality of LLMs;
generating, by the processor, a plurality of fine-tuned output prompts from each of the fine-tuned plurality of LLMs based on the received plurality of first datasets; and
outputting, by the processor, the generated plurality of fine-tuned output prompts on a user interface of a user device, wherein the output prompts being personalized based on user-specific intents derived from the domain complexity and the task complexity.

11. The method of claim 10, wherein determining the task complexity and the domain complexity of the plurality of second datasets by analyzing the type and the context of the plurality of second datasets comprises:
evaluating, by the processor, each dataset within the plurality of second datasets based on predefined complexity metrics corresponding to nature of tasks and related domains, wherein the predefined complexity metrics comprise a task operation count metric, a subtask interdependence metric, a data variability metric, a domain knowledge breadth metric, and a concept interrelationship metric;
identifying, by the processor, at least one task in a specific domain by analyzing the type and the context of the plurality of second datasets, wherein the at least one task comprises at least one of a first complexity level comprising simple tasks and a second complexity level comprising complex interdependent subtasks with variability, and wherein the context comprises specific conditions for performing the tasks, and wherein the type of dataset corresponds to a plurality of task categories comprising at least one of a text editing, a simplification, and a translation;
mapping, by the processor, the identified at least one task to a plurality of pre-stored tasks in a database, wherein the identified at least one task being correlated to hierarchical relationships, specific knowledge requirements, and diversity of concepts within the domain; and
determining, by the processor, the task complexity, and the domain complexity of the plurality of second datasets based on the mapping and results of evaluation.

12. The method of claim 10, wherein determining the embedded representation for the plurality of second datasets based on the number of tasks, the determined task complexity, and the determined domain complexity comprises:
generating, by the processor, the feature vector representations indicating a plurality of complexity characteristics relevant to the tasks and the domain, wherein the plurality of complexity characteristics comprise variations and types in task complexity;
encoding, by the processor, the plurality of second datasets using at least one of a sentence-level encoding, a token embedding, and an averaged word token embedding, wherein the sentence-level encoding maps sentences to a multi-dimensional vector space using a pre-trained encoder model, the token embedding comprises representations of each datasets for downstream tasks, and wherein the averaged word token embedding computes an average of word embeddings for sentence-level representation to aggregate token-level features;
correlating, by the processor, the task complexity and the domain complexity with the encoded plurality of second datasets based on the number of tasks and domain-specific requirements to determine alignment with the plurality of complexity characteristics;
determining, by the processor, a performance level of each of the sentence-level encoding, the token embedding and the averaged word token embedding based on a clustering accuracy, a separation of task-related data, and data relationships, wherein the performance level being assessed based on a cohesion score to evaluate cohesion within the plurality of clusters and separation between the plurality of clusters; and
determining, by the processor, an appropriate embedded representation for the plurality of second datasets based on the determined performance level.

13. The method of claim 10, wherein generating the plurality of clustered datasets by clustering the embedded representation of the plurality of second datasets into the plurality of clusters based on the cluster space value, the latent-space representation, and the pre-learnt embedding spaces comprises:
determining, by the processor, a plurality of tasks to be performed based on the embedded representation of the plurality of second datasets, wherein the plurality of tasks comprises at least one of text editing, language translation, speech-to-text conversion, image processing, language processing, question answering, image editing, video editing, software content generation and content modification, and wherein the plurality of tasks being determined by analyzing latent patterns in the embedded representation to identify a plurality of task categories;
determining, by the processor, a relevance of the plurality of second datasets to the determined plurality of tasks by analyzing semantic similarities and applicability, wherein the relevance being assessed using a cosine similarity value between dataset embeddings and task-specific pre-learned embedding spaces;
clustering, by the processor, the embedded representation using the AI based clustering model based on the determined plurality of tasks and the determined relevance, wherein the clustering embeds the cluster space value to evaluate distribution and proximity of data points within each cluster, and wherein the clustering being evaluated using a cohesion score to derive an optimal number of clusters corresponding to the number of tasks; and
generating, by the processor, the plurality of clustered datasets based on the clustering, wherein each cluster represents a category of task-related knowledge.

14. The method of claim 10, further comprising:
computing, by the processor, at least one text evaluation metric for the plurality of fine-tuned LLMs, wherein the at least one text evaluation metric comprises quantitative measures of text generation and text modification, operation evaluation metrics, and similarity metrics;
evaluating, by the processor, a performance of the plurality of fine-tuned LLMs based on the at least one text evaluation metric, wherein the plurality of fine-tuned LLMs being compared to baseline models to determine an accuracy level, a coherence level, and a task-specific effectiveness level; and
selecting, by the processor, at least one LLM for subsequent fine-tuning based on results of evaluation.

15. The method of claim 10, wherein generating the plurality of sampled datasets by sampling the plurality of clustered datasets based on the sampling weights and the distances to the centroid value of each cluster comprises:
determining, by the processor, a cosine distance between each data point in the plurality of clustered datasets and the centroid value of a corresponding cluster in the latent space, wherein the centroid value represents an average position of data points within the cluster, and wherein the cosine distance represents proximity to evaluate sample complexity;
generating, by the processor, the plurality of types of samples based on the determined cosine distance, wherein the plurality of types of samples being categorized as at least one of a low complexity indicating closeness to the centroid value and representativeness of core cluster knowledge, a medium complexity for intermediate distances, and a high complexity for maximum distances indicating complex tasks at a cluster periphery;
determining, by the processor, a behavioral pattern for the generated plurality of types of samples based on tasks associated with the plurality of clustered datasets, wherein the behavioral pattern identifies trends in task generalization and semantic similarities across samples; and
ranking, by the processor, each of the generated plurality of types of samples based on a proximity level of the determined cosine distance to the centroid value and the determined behavioral pattern.

16. The method of claim 10, wherein performing fine-tuning of the plurality of LLMs using the extracted plurality of base datasets and the selected plurality of sampled datasets comprises:
training, by the processor, the plurality of LLMs in a specific sequence based on the task complexity and the domain complexity using a subset of the plurality of the first datasets and the selected plurality of samples, wherein the subset of the plurality of the first datasets corresponds to plurality of second set of datasets.

17. The method of claim 10, wherein performing fine-tuning of the plurality of LLMs using the extracted plurality of base datasets and the selected plurality of sampled datasets comprises:
determining, by the processor, a distance between the extracted plurality of base datasets and the selected plurality of samples relative to the centroid value, wherein the distance being computed using a cosine similarity value;
determining, by the processor, the model hyperparameter values associated with each of the plurality of LLMs based on the determined distance, wherein the model hyperparameter values comprise at least one of a learning rate, a batch size, a number of training epochs, and the sampling weights;
selecting, by the processor, an LLM for fine-tuning based on the determined model hyperparameter values and compatibility with domain-specific pre-training data, wherein the selection prioritizes the plurality of LLMs with pre-existing knowledge aligned to the task complexity and the domain complexity; and
performing, by the processor, the fine-tuning of the selected LLM using the extracted plurality of base datasets and the selected plurality of samples, wherein the fine-tuning comprises adjusting the model hyper parameters, applying early stopping upon a predefined number of epochs, and adapting the LLM for personalized outputs based on the user intents.

18. The method of claim 17, wherein determining the model hyper parameter values associated with each of the plurality of LLMs based on the determined distance comprises:
identifying, by the processor, task-specific characteristics, and domain-specific characteristics by analyzing a domain knowledge derived from the plurality of second datasets, wherein the domain knowledge comprises semantic patterns and hierarchical relationships relevant to the tasks;
evaluating, by the processor, a cohesion level within the plurality of clusters and the distance between the plurality of clusters in the embedded representation of the plurality of second datasets by computing a clustering quality metric, wherein the clustering quality metric determines an optimal number of clusters corresponding to the number of tasks;
determining, by the processor, optimal sampling weights based on the clustering quality metric and the domain knowledge, wherein sampling weights control a proportion of complexity samples being proximate and distant to the centroid value; and
determining, by the processor, appropriate model hyper parameter values associated with each of the plurality of LLMs based on the determined optimal sampling weights and the evaluated cohesion level.

19. A non-transitory computer readable medium comprising a processor-executable instructions that cause a processor to:
receive a plurality of first datasets from a plurality of data sources, wherein the plurality of first datasets correspond to training datasets for training a plurality of Large Language Models (LLMs);
extract a plurality of base datasets from the received plurality of first datasets using a stratified sampling model, wherein the plurality of base datasets corresponds to a plurality of base sampled datasets present in the plurality of first datasets;
determine a plurality of second datasets based on the difference between the plurality of first datasets and the plurality of base datasets;
determine a task complexity and a domain complexity of the plurality of second datasets by analyzing a type and a context of the plurality of second datasets, wherein the task complexity comprises a level of difficulty based on a number of required operations and interdependence of subtasks, and wherein the domain complexity comprises an intricacy level of subject matter based on breadth of knowledge required and interrelationships among concepts;
determine an embedded representation for the plurality of second datasets based on a number of tasks, the determined task complexity, and the determined domain complexity, wherein the embedded representation comprises feature vector representations of the plurality of second datasets;
generate a plurality of clustered datasets by clustering the embedded representation of the plurality of second datasets into a plurality of clusters based on a cluster space value, a latent-space representation, and pre-learnt embedding spaces, wherein the plurality of clusters correspond to the number of tasks to be performed;
generate a plurality of sampled datasets by sampling the plurality of clustered datasets based on sampling weights and distances to a centroid value of each cluster, wherein the plurality of sampled datasets comprise data samples with a specific complexity value being proximate and distant to the centroid value, and wherein the sampling weights control a proportion of the specific complexity value;
select appropriate data samples from the generated plurality of sampled datasets based on the sampling weights and the distances to the centroid value of each cluster;
perform fine-tuning of the plurality of LLMs using the extracted plurality of base datasets and the selected plurality of sampled datasets, wherein the fine-tuning comprises adjusting model hyper parameters of the plurality of LLMs;
generate a plurality of fine-tuned output prompts from each of the fine-tuned plurality of LLMs based on the received plurality of first datasets; and
output the generated plurality of fine-tuned output prompts on a user interface of a user device, wherein the output prompts being personalized based on user-specific intents derived from the domain complexity and the task complexity.

20. The non-transitory computer readable medium of claim 19, wherein the processor-executable instructions cause the processor to:
compute at least one text evaluation metric for the plurality of fine-tuned LLMs, wherein the at least one text evaluation metric comprises quantitative measures of text generation and text modification, operation evaluation metrics, and similarity metrics;
evaluate a performance of the plurality of fine-tuned LLMs based on the at least one text evaluation metric, wherein the plurality of fine-tuned LLMs being compared to baseline models to determine an accuracy level, a coherence level, and a task-specific effectiveness level; and
select at least one LLM for subsequent fine-tuning based on results of evaluation.
